(19) United States
(12) Patent Application Publication
(10) Pub. No.: US 2016/0253460 A1
(43) Pub. Date: Sep. 1, 2016

(54) DIAGNOSTIC INFORMATION DISPLAY CONTROL DEVICE, METHOD, AND PROGRAM

(71) Applicant: FUJIFILM Corporation, Tokyo (JP)

(72) Inventor: Shoji KANADA, Ashigarakami-gun (JP)

(73) Assignee: FUJIFILM Corporation, Tokyo (JP)

(21) Appl. No.: 15/151,728

(22) Filed: May 11, 2016

Related U.S. Application Data
(63) Continuation of application No. PCT/JP2014/005714, filed on Nov. 13, 2014.

(30) Foreign Application Priority Data
Nov. 14, 2013 (JP) 2013-235871

(51) Int. Cl. G06F 19/00; G06F 3/0484; G06F 3/0482

(52) U.S. Cl. CPC G06F 19/325; G06F 3/0482; G06F 3/04842; G06F 19/345

(57) ABSTRACT

A disease information acquisition unit acquires disease information of a patient and information of a disease period of the disease information, a display period designation receiving unit receives a designation of information of a display period for which medical data is displayed, and a display control unit displays a list of the disease information in which at least a part of the disease period is included in the display period and that acquires medical data of the medical treatment items, which are associated with at least one selected piece of disease information in the list of the disease information, and displays the acquired medical data in time series. In a case in which the display period has been changed, the display control unit displays a changed list of disease information in which at least a part of the disease period is included in a display period after the change.

### CROSS-REFERENCE TO RELATED APPLICATIONS

This application is a Continuation of PCT International Application No. PCT/JP2014/005714 filed on Nov. 13, 2014, which claims priority under 35 U.S.C. §119(a) to Japanese Patent Application No. 2013-235871 filed on Nov. 14, 2013. Each of the above applications is hereby expressly incorporated by reference, in its entirety, into the present application.

### BACKGROUND OF THE INVENTION

1. Field of the Invention

The present invention relates to a diagnostic information display control device, method, and program for displaying the medical data of a plurality of medical treatment items acquired in time series.

2. Description of the Related Art

In recent years, a system has been proposed that displays medical data, such as the results of various inspections performed on a patient, on a display in order to allow the progress of the disease to be checked or the treatment policy or the like to be determined when a doctor performs medical treatment.

When displaying the medical data of a patient in such a system, for example, in a case in which the medical treatment period of the patient is long, all pieces of the medical data may not fit on one screen.

Therefore, JP2001-290885A has proposed a system in which a user designates a predetermined medical treatment period and only the medical data obtained in the medical treatment period is displayed in one screen.

### SUMMARY OF THE INVENTION

However, in recent years, the number of diseases from which one patient suffers in the same period has increased due to medical advances and aging. In addition, according to an increase in the number of diseases, the amount of additional data, such as the number of inspections that are performed for each of the diseases, has also become very large. In a case in which one patient suffers from a plurality of diseases in the same period, in the system disclosed in JP2001-290885A, medical data relevant to the plurality of diseases is simultaneously displayed. Therefore, it is not possible to immediately check the medical data.

When performing medical treatment, the doctor performs medical treatment in consideration of the relationship between diseases. Accordingly, it is important to manage the medical data in units of a disease. For example, there is a case in which it is necessary to check not only a disease from which the patient suffers but also a disease, from which the patient suffered in the past and which may affect the current disease. In the system disclosed in JP2001-290885A, however, since the management is not performed in units of a disease, it is difficult to check the relationship between a current disease and a past disease with a simple operation.

JP2012-247879A has proposed displaying an examination part examined in a designated period with a mark and displaying the electronic medical record information or inspection information regarding the disease of the examination part. In the technique disclosed in JP2012-247879A, only the inspection information regarding a specific examination part can be displayed. For example, it is not possible to extract and display inspection information regarding a disease for which an examination part is not registered. In addition, the filtering of inspection information displayed only in the examination part is not possible. Similarly, in this case, the medical treatment efficiency is poor in a case where a plurality of diseases are present in the same period.

In view of the aforementioned situation, it is an object of the present invention to provide a diagnostic information display control device, method, and program capable of immediately displaying medical data relevant to a specific disease and immediately displaying not only medical data relevant to a current disease but also medical data relevant to past diseases with a simple operation.

A diagnostic information display control device of the present invention includes: a disease information acquisition unit that acquires disease information of a patient and information of a disease period of the disease information; a corresponding medical treatment item information storage unit that stores corresponding medical treatment item information in which the disease information and medical treatment items relevant to the disease information are associated with each other; a display period designation receiving unit that receives a designation of information of a display period for which medical data of the medical treatment items is displayed; and a display control unit that displays a list of the disease information in which at least a part of the disease period is included in the display period and that acquires medical data of the medical treatment items, which are associated with at least one selected piece of disease information in the list of the disease information, based on the corresponding medical treatment item information and displays the acquired medical data in time series. In a case in which the display period has been changed, the display control unit displays a changed list of disease information in which at least a part of the disease period is included in a display period after the change.

In the diagnostic information display control device of the present invention, in a case in which the display period has been changed, for disease information selected in advance before the change, the display control unit can continue to display the disease information in a disease list even if the disease period is not included in a display period after the change.

When an operation of changing the display period is received by the display period designation receiving unit and a time axis display of the display period is changed according to the change operation, the display control unit can change a list of the disease information to a list of disease information corresponding to the changed display period and display the changed list, and for the medical data, can display in time series only medical data of the medical treatment items corresponding to disease information selected in advance before receiving the display period change operation and display the medical data corresponding to a display period after the change according to the display period change operation.

It is possible to further include a priority setting unit that sets priorities for a plurality of pieces of disease information in a case of displaying the plurality of pieces of disease information in a list, and the display control unit can display the plurality of pieces of disease information in a list based on the priorities.

The display control unit can automatically select disease information having a highest priority and disease information up to a priority set in advance from the highest priority, among the plurality of pieces of disease information for which priorities are set by the priority setting unit, and display medical data of medical treatment items relevant to the selected disease information.

It is possible to further include a disease information selection receiving unit that receives a selection of at least a piece of the disease information displayed in a list by the display control unit, and the display control unit can display medical data of medical treatment items associated with the disease information received by the disease information selection receiving unit.

The priority setting unit can acquire information of the number of associated medical treatment items for each of the plurality of pieces of disease information, and set a priority of the disease information based on the number of items.

The priority setting unit can acquire information of the number of acquisitions of medical data of the associated medical treatment items for each of the plurality of pieces of disease information, and set a priority of the disease information based on the number of acquisitions.

The priority setting unit can acquire information of the number of times of display or information of display period of medical data of the associated medical treatment items for each of the plurality of pieces of disease information, and set a priority of the disease information in descending order of the number of times of display or the display period.

The priority setting unit can acquire information of an admission period of the patient, and set a priority of disease information corresponding to the admission period, among the plurality of pieces of disease information, to be high.

The priority setting unit can acquire information of a medical department to which a user belongs, and set a priority of disease information relevant to the medical department information, among the plurality of pieces of disease information, to be high.

The disease period can be set as a period from start to end of the disease information or as an admission period relevant to the disease information.

A diagnostic information display control method of the present invention includes: acquiring disease information of a patient and information of a disease period of the disease information; receiving a designation of information of a display period for which medical data of the medical treatment items is displayed; displaying a list of the disease information in which at least a part of the disease period is included in the display period, and acquiring medical data of the medical treatment items, which are associated with at least a piece of disease information in the list of the disease information, and displaying the acquired medical data in time series; and in a case in which the display period has been changed, displaying a changed list of disease information in which at least a part of the disease period is included in a display period after the change.

A diagnostic information display control program of the present invention causes a computer to function as: a disease information acquisition unit that acquires disease information of a patient and information of a disease period of the disease information; a corresponding medical treatment item information storage unit that stores corresponding medical treatment item information in which the disease information and medical treatment items relevant to the disease information are associated with each other; a display period designation receiving unit that receives a designation of information of a display period for which medical data of the medical treatment items is displayed; and a display control unit that displays a list of the disease information in which at least a part of the disease period is included in the display period and that acquires medical data of the medical treatment items, which are associated with at least one piece of disease information in the list of the disease information, based on the corresponding medical treatment item information and displays the acquired medical data in time series. In a case in which the display period has been changed, the display control unit displays a changed list of disease information in which at least a part of the disease period is included in a display period after the change.

According to the diagnostic information display control method, device, and program of the present invention, since the designation of the information of the display period for which the medical data is displayed is received, the list of disease information in which at least a part of the disease period is included in the display period is displayed, and the medical data of the medical treatment items associated with at least a piece of disease information in the list of the disease information is acquired and displayed in time series, the medical data relevant to a specific disease for which the disease period is included in the designated display period can be immediately displayed. In addition, since the list of disease information is also changed according to the change in the display period, not only the medical data relevant to the current disease but also the medical data relevant to past diseases can be immediately displayed with a simple operation.

### BRIEF DESCRIPTION OF THE DRAWINGS

FIG. 1 is a block diagram showing the schematic configuration of a diagnostic information display system using a first embodiment of a diagnostic information display control device of the present invention.

FIG. 2 is a diagram showing an example of a diagnostic information display screen.

FIG. 3 is a flowchart illustrating the operation of the diagnostic information display system shown in FIG. 1.

FIG. 4 is a block diagram showing the schematic configuration of a diagnostic information display system using a second embodiment of the diagnostic information display control device of the present invention.

FIG. 5 is a diagram showing an example of disease information and disease period information of the disease information.

FIG. 6 is a diagram illustrating a case of setting priorities based on disease period information.

FIG. 7 is a diagram showing an example of medical treatment items relevant to each piece of disease information.

FIG. 8 is a diagram showing an example of the number of acquisitions of medical data of medical treatment items relevant to each piece of disease information.

FIG. 9 is a diagram showing an example of the display period of medical data of medical treatment items relevant to each piece of disease information.

FIG. 10 is a diagram illustrating an example of a method of setting priorities for disease information based on an admission period.

FIG. 11 is a diagram showing an example of a table in which a medical department and disease information are associated with each other.

### DESCRIPTION OF THE PREFERRED EMBODIMENTS

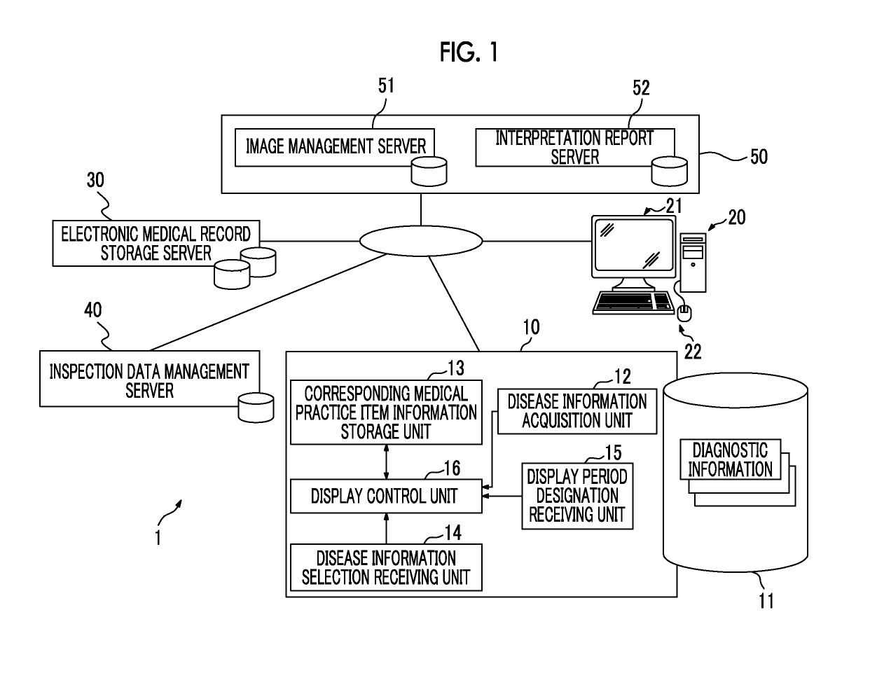

Hereinafter, a diagnostic information display system using a first embodiment of a diagnostic information display control device, method, and program of the present invention will be described in detail with reference to the diagrams. FIG. 1 is a block diagram showing the schematic configuration of a diagnostic information display system 1 of the present embodiment.

As shown in FIG. 1, the diagnostic information display system 1 of the present embodiment includes a diagnostic information display control device 10, a treatment department terminal 20, an electronic medical record storage server 30, an inspection data management server 40, and a diagnostic imaging system 50, and these are connected to each other through, for example, a wired or wireless LAN or a network, such as the Internet.

The diagnostic information display control device 10 receives the identification information of a patient that is input in the treatment department terminal 20, collects diagnostic information regarding the patient from the electronic medical record storage server 30, the inspection data management server 40, and the diagnostic imaging system 50, generates a diagnostic information display screen by integrating the collected information, and displays the diagnostic information display screen on a monitor 21 of the treatment department terminal 20.

Specifically, as shown in FIG. 1, the diagnostic information display control device 10 includes a diagnostic information storage unit 11, a disease information acquisition unit 12, a corresponding medical treatment item information storage unit 13, a disease information selection receiving unit 14, a display period designation receiving unit 15, and a display control unit 16.

The diagnostic information display control device 10 is a device obtained by installing an embodiment of the diagnostic information display control program of the present invention in a computer. The diagnostic information display control program is executed by a central processing unit (CPU), so that the diagnostic information storage unit 11, the disease information acquisition unit 12, the corresponding medical treatment item information storage unit 13, the disease information selection receiving unit 14, the display period designation receiving unit 15, and the display control unit 16 function. As the diagnostic information display control program, a diagnostic information display control program recorded on a recording medium, such as a CD-ROM, may be used, or a diagnostic information display control program downloaded from a server or the like through the Internet may be used, or a diagnostic information display control program provided by Software as a Service (SaaS) through the Internet may be used.

The diagnostic information storage unit 11 includes a storage device, such as a hard disk, and the diagnostic information of a patient specified by the identification information input from the treatment department terminal 20 is stored. The identification information of a patient and the diagnostic information of the patient are managed so as to be associated with each other. The diagnostic information is read from the electronic medical record storage server 30, the inspection data management server 40, and the diagnostic imaging system 50 based on the identification information of the patient, and is stored in the diagnostic information storage unit 11.

As diagnostic information, there are basic information, such as the patient's name, age, and sex, disease information indicating the type of the patient's disease, disease period information indicating a period for which the patient suffers from the disease, and various kinds of medical data including a dosage, a drip amount, subject inspection data, vital, a radiological image, and an ultrasound image. The medical data may be any data obtained for the purpose of diagnosis and treatment of patients. In addition, the medical data may be not only numerical values or image information but also data expressed in a text other than numerical values (character string). As the medical data expressed in a text as described above, for example, there is medical data indicating “presence” or “absence” of an inspection or medical data indicating whether the inspection result is “good” or “bad”.

Although the basic information, the disease information, and the disease period information that are included in the diagnostic information are read from the electronic medical record of the patient in the electronic medical record storage server 30, these pieces of information may not necessarily acquired from the electronic medical record, and other servers or the like may manage these pieces of information and the information may be acquired from the servers.

The disease information includes not only the information of a disease that the patient suffers at present but also the information of a disease that the patient suffered in the past. In addition, it is assumed that the disease period information is set for each piece of the disease information. The disease period information in the present embodiment is information indicating a period from the start (onset) to the end (complete cure) of each disease, and the start (onset) and the end (complete cure) of each disease are set in advance by the user together with the disease information.

Medical data included in the diagnostic information, for example, a dosage, a drip amount, and vital, are read from the electronic medical record in the electronic medical record storage server 30. Inspection data, such as subject inspection data, is read from the inspection data management server 40. Image information is read from an image management server 51 of the diagnostic imaging system 50. However, medical data stored in other servers or the like may be acquired without being limited to the above.

The disease information acquisition unit 12 acquires the disease information of a patient and the disease period information of the disease that are included in the diagnostic information, and outputs such information to the display control unit 16.

In the corresponding medical treatment item information storage unit 13, a table in which the disease information of a patient and medical treatment items relevant to the disease information are associated with each other is stored in advance. The medical treatment items relevant to the disease information include an inspection item required to check the progress of the disease, an item of medication or dripping required to treat the disease, and the like. A specific example of the medical treatment item relevant to the disease information will be described in detail later.

The display control unit 16 displays a list of disease information of the patient specified by the identification information on the diagnostic information display screen. Specifically, the display control unit 16 of the present embodiment acquires disease information of a patient and disease period information of the disease information that are output from the disease information acquisition unit 12, extracts disease information in which at least a part of the disease period is included in a display period to display the medical data, of the disease information, and displays the extracted disease information in a list.

In the present embodiment, the initial display period is set as a period from the current time to the past time set in advance by the user. For example, a period from the current time to the past time, such as one month ago or three months ago, is set as the initial display period. Accordingly, first, the display control unit 16 extracts disease information in which at least a part of the disease period is included in the initial display period, and displays the disease information in a list. In a case in which there is no disease other than the current disease during the initial display period, only the disease information of the current disease is displayed.

The display control unit 16 specifies a medical treatment item associated with at least a piece of disease information in the list of disease information, which is being currently displayed, with reference to the table stored in the corresponding medical treatment item information storage unit 13, acquires medical data of the specified medical treatment item, and displays the medical data on the diagnostic information display screen in time series.

The disease information selection receiving unit 14 receives a selection of at least a piece of disease information from the disease information displayed by the display control unit 16 as described above. The display control unit 16 acquires the disease information received by the disease information selection receiving unit 14, reads and acquires medical data of the medical treatment item associated with the disease information from the diagnostic information storage unit 11, and displays the medical data on the diagnostic information display screen.

The display period designation receiving unit 15 receives a designation of the display period of medical data. Specifically, the display period designation receiving unit 15 receives a designation of a different display period from the initial display period described above, and the display period received by the display period designation receiving unit 15 is output to the display control unit 16.

In a case in which the display period has been changed, the display control unit 16 specifies disease information in which at least a part of the disease period is included in the changed display period, changes the list of the currently displayed disease information to a list of the specified disease information, and displays the changed list.

Then, if necessary, at least a piece of disease information in the list of disease information after the change is selected by the user, and the selected information is received by the disease information selection receiving unit 14. The display control unit 16 acquires the disease information received by the disease information selection receiving unit 14 again, reads and acquires medical data of the medical treatment item associated with the disease information from the diagnostic information storage unit 11, and displays the medical data on the diagnostic information display screen.

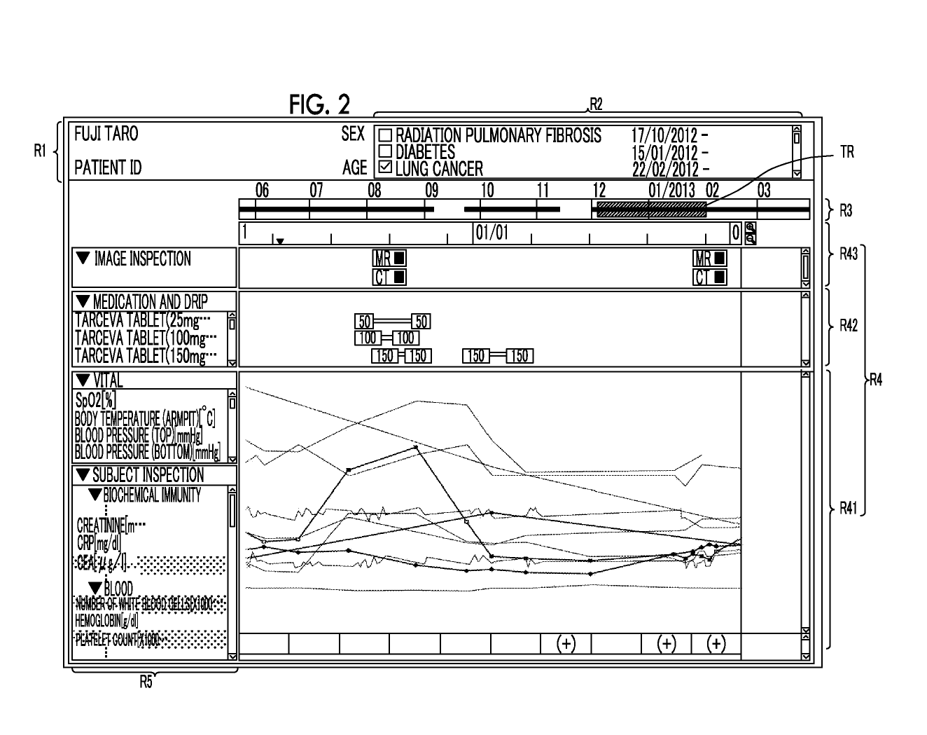

Next, the diagnostic information display screen displayed on the monitor 21 of the treatment department terminal 20 by the display control unit 16 will be described. FIG. 2 shows an example of the diagnostic information display screen.

As shown in FIG. 2, the diagnostic information display screen includes a basic information display field R1, a disease information list display field R2, a medical data acquisition period display field R3, a medical data display field R4, and a medical treatment item list display field R5.

The basic information display field R1 is a field in which the basic information of a patient, such as identification information (patient ID), name, age, and sex, is displayed.

The disease information list display field R2 is a field in which, in the disease information of the patient acquired by the disease information acquisition unit 12 as described above, disease information in which at least a part of the disease period is included in the display period of medical data set in advance or in the display period of medical data designated by the user is displayed in a list. In the disease information list display field R2, for each piece of disease information, the start (onset) date and time and the end (complete cure) date and time of each disease are displayed. For the information of a disease from which the patient suffers at present, only the start (onset) date and time of the disease is displayed since the end (complete cure) date and time is not set.

In addition, in the disease information list display field R2, a check box is displayed for each piece of disease information. When this check box is checked by the user, disease information to be displayed in the medical data is selected from the disease information list. The selected information is acquired by the disease information selection receiving unit 14 as described above.

The medical data acquisition period display field R3 is a field in which the outline of a period for which the medical data for the patient specified by the identification information has been acquired is displayed. The horizontal axis of the medical data acquisition period display field R3 indicates a time axis, and the right end indicates the current date and time. In the medical data acquisition period display field R3, a period for which medical data is present is basically displayed as a bar-shaped graph extending in the horizontal direction. However, in order to perform a schematic display herein, in a case in which a period for which no medical data is present is shorter than the period set in advance, a continuous bar-shaped graph is displayed by assuming the period to be a period for which medical data is present.

In addition, the medical data acquisition period display field R3 is a field to receive a designation of a display period of the horizontal axis of the medical data display field R4 in which medical data is displayed. As shown in FIG. 2, in the medical data acquisition period display field R3, a rectangular region TR is input by the user, and a period from the time of the left end to the time of the right end of the rectangular region TR is designated as the display period of the medical data. In addition, the display period designated in the medical data acquisition period display field R3 is set as the scale of the display period of the horizontal axis of the medical data display field R4. Specifically, the time of the left end of the rectangular region TR of the medical data acquisition period display field R3 is set as the time of the left end of the medical data display field R4, and the time of the right end of the rectangular region TR is set as the time of the right end of the medical data display field R4. That is, by changing the position of the rectangular region TR by the user, the time axis display of the display period of the medical data display field R4 is changed. The display period designation receiving unit 15 described above receives a display period change operation.

Therefore, the user can arbitrarily change the display period of the medical data of the medical data display field R4. In the present embodiment, as described above, the display period is designated by setting the rectangular region TR in the medical data acquisition period display field R3. However, without being limited to the above, for example, a scroll bar may be provided, so that the display period can be changed by scrolling the medical data display field R4 in the horizontal direction using the scroll bar. Alternatively, it is also possible to change the display period by extending the medical data display field R4 in the horizontal direction.

The medical treatment item list display field R5 is a field in which medical treatment items relevant to the disease information selected by the user in the disease information list display field R2 are displayed. The medical treatment items relevant to the disease information are read from the corresponding medical treatment item information storage unit 13, and are displayed in the medical treatment item list display field R5 by the display control unit 16.

The medical data display field R4 is a field in which the medical data of the medical treatment item displayed in the medical treatment item list display field R5 is displayed, and includes a numerical data display field R41, a dosing period display field R42, and an image information display field R43.

The numerical data display field R41 is a field to display subject inspection data, vital data, blood test data, and the like acquired as numerical data. For example, as shown in FIG. 2, numerical data can be displayed as a graph. Instead of such a graph display, numerical data can also be displayed as a table in a text. The graph display and the table display can be switched therebetween by the user.

Each medical treatment item displayed in the medical treatment item list display field R5 can be selected by the user, and medical data of the medical treatment item selected in this field is highlighted in the medical data display field R4. When a medical treatment item is selected by the user, the cell of the medical treatment item is displayed in a different form from other cells (for example, color-displayed). The graph of the medical data of the selected medical treatment item is color-displayed, and the medical data of other medical treatment items is highlighted (for example, displayed in light gray).

In the dosing period display field R42, numerical data, such as a dosage or a drip amount, is displayed in a text, and a period for which medication or dripping has been performed is displayed in a segment extending in the horizontal direction.

In addition, the image information display field R43 is a field to display image information, and it is possible to display a text showing the modality of image information and the thumbnail of image information. The position where the thumbnail is displayed indicates a time at which the image information is acquired. When the thumbnail displayed in the image information display field R43 has been selected by the user, the original image is displayed on another screen.

The treatment department terminal 20 includes a monitor and input devices, such as a keyboard and a mouse. The monitor of the treatment department terminal 20 displays the diagnostic information display screen shown in FIG. 2. The keyboard and the mouse of the treatment department terminal 20 receive various inputs from the user, such as an input of the identification information of the patient, an input of the display period of medical data, and an input for designating the check box in the disease information list display field R2.

The electronic medical record storage server 30 manages the electronic medical records of a plurality of patients. In the electronic medical record storage server 30, the electronic medical records of a plurality of patients are stored so as to be associated with the identification information of the patients. The electronic medical record storage server 30 acquires the identification information of a patient input in the treatment department terminal 20, and outputs the information of the electronic medical record associated with the identification information to the diagnostic information display control device 10. As described above, information including the basic information of the patient, types and amounts of drugs administered and dripped, a dosing period, vital information, disease information, and disease period information of the disease information is included in the electronic medical records.

The inspection data management server 40 manages the inspection data, such as subject inspection data or blood test data of a plurality of patients. In the inspection data management server 40, inspection data of a plurality of medical treatment items of each patient is stored so as to be associated with the identification information of the patient. The inspection data management server 40 acquires the identification information of a patient input in the treatment department terminal 20, and outputs the inspection data associated with the identification information to the diagnostic information display control device 10. There is also a form of inspection data that is once output as an electronic medical record and is stored as an electronic medical record. In this case, inspection data is output to the diagnostic information display control device 10 from the electronic medical records.

The diagnostic imaging system 50 is a system for managing the image diagnosis information of a plurality of patients. The diagnostic imaging system 50 includes the image management server 51 and an interpretation report server 52. In the image management server 51, image information, such as a radiological image of each patient, is stored so as to be associated with the identification information of the patient. In addition, an interpretation report created by the doctor who observes the radiological image or the like is stored in the interpretation report server 52, and the interpretation report is stored so as to be associated with the image information stored in the image management server 51. The diagnostic imaging system 50 acquires the identification information of a patient input in the treatment department terminal 20, and outputs image information associated with the identification information, information of the modality, or the interpretation report to the diagnostic information display control device 10.

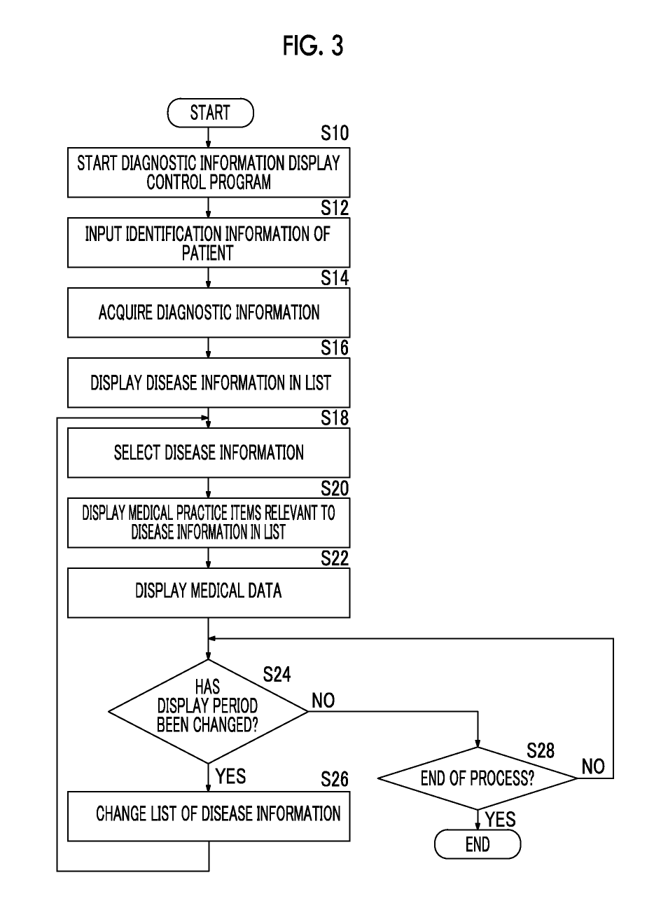

Next, the operation of the diagnostic information display system 1 of the present embodiment will be described with reference to the flow chart shown in FIG. 3.

First, in the treatment department terminal 20, a medical data display control program is started by the user, and a diagnostic information display screen shown in FIG. 2 is displayed on the monitor 21 (S10).

Then, in the treatment department terminal 20, identification information of the patient is input, and the identification information of the patient is acquired by the display control unit 16 of the diagnostic information display control device 10 (S12).

The display control unit 16 reads and acquires diagnostic information, such as the basic information of the patient, disease information, disease period information of the disease information, and medical data, from the electronic medical record storage server 30, the inspection data management server 40, or the diagnostic imaging system 50 based on the input identification information of the patient, and temporarily stores the acquired diagnostic information in the diagnostic information storage unit 11 (S14).

Then, by the display control unit 16, the basic information of the patient is read from the diagnostic information storage unit 11, and the basic information is displayed on the basic information display field R1 of the diagnostic information display screen.

In addition, disease information of the patient and disease period information of the disease information are acquired by the disease information acquisition unit 12, and are output to the display control unit 16. In a case in which no disease information of the patient is registered and no disease information is stored in the diagnostic information storage unit 11, the disease information of the patient is set and input by the user, and the new disease information and disease period information of the disease information are additionally registered. Then, the new disease information and the disease period information are output to the display control unit 16.

The display control unit 16 compares the disease period of the input disease information with the display period of the initial medical data set in advance, specifies disease information in which at least a part of the disease period is included in the display period, and displays the specified disease information in a list in the disease information list display field R2 of the diagnostic information screen (S16).

Then, from the list of the disease information displayed in the disease information list display field R2, a check box of at least a piece of disease information is selected by being checked by the user (S18). If the disease information is selected, the selected information is received by the disease information selection receiving unit 14, and is output to the display control unit 16.

Based on the input selected information of the disease information, the display control unit 16 acquires the information of medical treatment items relevant to the selected disease information with reference to the table stored in the corresponding medical treatment item information storage unit 13. Then, the display control unit 16 displays the acquired medical treatment items relevant to the disease information in the medical treatment item list display field R5 of the diagnostic information display screen (S20). In addition, the display control unit 16 reads the medical data of the medical treatment items displayed in the medical treatment item list display field R5 from the diagnostic information storage unit 11, and displays the medical data in the medical data display field R4 (S22). In this case, the initial display period is set on the horizontal axis of the medical data display field R4.

The display control unit 16 acquires a period, for which the medical data of the patient has been acquired, based on the diagnostic information stored in the diagnostic information storage unit 11, and displays the outline of the period, for which the medical data has been acquired, in the medical data acquisition period display field R3, based on the acquired period.

Then, in a case in which the user wants to observe medical data relevant to the past disease information that is different from the medical data being currently displayed, the user performs a display period change operation by changing the position of the rectangular region TR displayed in the medical data acquisition period display field R3. As a result, the setting is changed to a desired past display period (S24, YES).

In a case in which there is a change in the display period by the user, the display control unit 16 compares the disease period of the disease information of the patient stored in the diagnostic information storage unit 11 with the changed display period, specifies disease information in which at least a part of the disease period is included in the display period, and displays a list of the specified disease information that has been changed from the list of the disease information displayed in the disease information list display field R2 (S26).

Then, from the list of the disease information displayed in the disease information list display field R2, a check box of at least a piece of disease information is selected again by being checked by the user (S18). If the disease information is selected, the selected information is received by the disease information selection receiving unit 14, and is output to the display control unit 16.

Based on the input selected information of the disease information, the display control unit 16 acquires the information of medical treatment items relevant to the selected disease information again with reference to the table stored in the corresponding medical treatment item information storage unit 13. Then, the display control unit 16 displays the acquired medical treatment items relevant to the disease information in the medical treatment item list display field R5 of the diagnostic information display screen (S20). In addition, the display control unit 16 reads the medical data of the medical treatment items displayed in the medical treatment item list display field R5 from the diagnostic information storage unit 11, and displays the medical data in the medical data display field R4 (S22). In this case, a display period after the change is set on the horizontal axis of the medical data display field R4.

Until, for example, past disease information is selected by checking the check box of the disease information in step 18 (S18) after receiving the display period change operation, the horizontal axis of the medical data display field R4 is set and displayed as the changed display period. In addition, as medical data, medical data of the changed display period, which is medical data based on the disease information that has been selected until then, is displayed. Display updating of the medical data is performed in real time in conjunction with an operation of changing the display period by setting the rectangular region TR in the medical data acquisition period display field R3.

By updating the display of medical data as described above, it is possible to simultaneously see the information regarding from which disease the patient suffered in the past time selected during the display period change operation and a state in the past time of medical data of medical treatment items relevant to the disease at the present time that has already been selected. This is beneficial to medical treatment since it is possible to see the relationship between the past disease and the current disease.

On the other hand, in a case in which there is no change in the display period by the user (S24, NO) and an instruction to end the diagnostic information display control program is input (S28, YES), the process is ended.

According to the diagnostic information display system 1 of the present embodiment, the designation of the information of the display period for displaying the medical data is received, the list of disease information in which at least a part of the disease period is included in the display period is displayed, and the medical data of medical treatment items associated with at least a piece of disease information in the list of the disease information is acquired and displayed in time series. Therefore, it is possible to immediately display medical data relevant to a specific disease in which the disease period is included in the designated display period.

In addition, since the list of the disease information is changed according to the change in the display period, it is possible to immediately display not only medical data relevant to the current disease but also medical data relevant to the past diseases. The disease information of the disease information list display field R2 is displayed and updated in real time together with the display period change operation to select a display period. In the medical treatment item list display field R5 or the medical data display field R4, however, medical data relevant to the disease information selected at the present time continues to be scroll-displayed according to the change in the display period until the past disease is selected in the disease information list display field R2 (during the change in the display period). For this reason, it is possible to avoid that medical data to be displayed along with the change in the display period is excessively switched. Therefore, this is easy-to-use since the past disease is checked and there is no load on the eyes of the user.

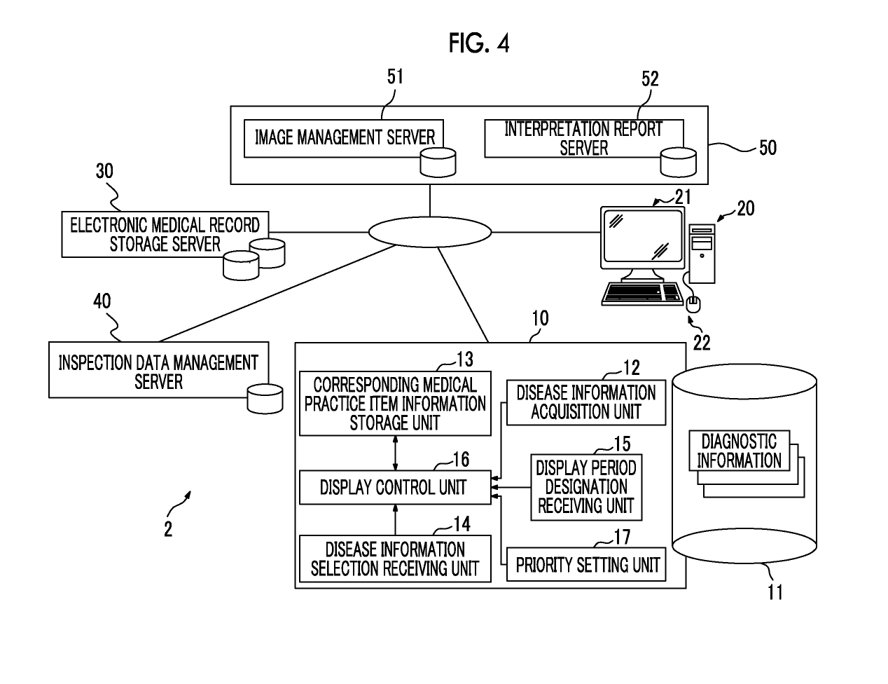

Next, a diagnostic information display system using a second embodiment of the diagnostic information display control device, method, and program of the present invention will be described in detail with reference to the diagrams. FIG. 4 is a block diagram showing the schematic configuration of a diagnostic information display system 2 of the present embodiment.

The method of displaying the list of disease information in the disease information list display field R2 in the diagnostic information display system 2 of the second embodiment is different from that in the diagnostic information display system 1 of the first embodiment. In the diagnostic information display system 2 of the second embodiment, when displaying a plurality of pieces of disease information in a list, priorities are set for the plurality of pieces of disease information, and the plurality of pieces of disease information are displayed in a list according to the set priorities. Other configurations and operations are the same as those of the diagnostic information display system 1 of the first embodiment.

Specifically, as shown in FIG. 4, the diagnostic information display system 2 of the second embodiment includes a priority setting unit 17 that sets a priority for each of a plurality of pieces of disease information, and the display control unit 16 displays the plurality of pieces of disease information in a list based on the priority set for each piece of the disease information by the priority setting unit 17.

As a method of displaying the list of a plurality of pieces of disease information based on priorities, for example, a plurality of pieces of disease information may be displayed in a list from the top to the bottom of the disease information list display field R2 in descending order of priorities. On the contrary, a plurality of pieces of disease information may be displayed in a list from the bottom to the top of the disease information list display field R2 in descending order of priorities. In addition, for each piece of the disease information, numbers corresponding to the priorities may be displayed in a text.

Instead of displaying the priority according to the display position of disease information as described above, the priority may be displayed by changing the color of the text (character string) of a disease name for each piece of disease information, or the priority may be displayed by changing the color of a cell where the disease name is displayed for each piece of disease information. That is, any display method may be adopted as long as the user can recognize the priority of each piece of disease information through the display method.

Thus, by displaying a plurality of pieces of disease information in a list according to priorities, the user can easily select disease information to be displayed of medical data. Accordingly, it is possible to improve the diagnostic efficiency. In addition, as in the first embodiment, medical data is summarized and managed in units of a disease, and the screen is scrolled so that only the disease list is displayed and updated during the display period change. Therefore, it is possible to provide an easy-to-use system that suppresses the flickering of the screen by preventing the excessive display switching of medical data while checking the relationship between the current disease and the past disease.

Next, the above method of setting priorities for a plurality of pieces of disease information in the priority setting unit 17 will be specifically described.

As one of the priority setting methods, for example, there is a method of setting priorities based on the disease period info nation of a plurality of pieces of disease information. Specifically, for example, it is possible to set the priorities in order of the start (onset) time close to the present time.

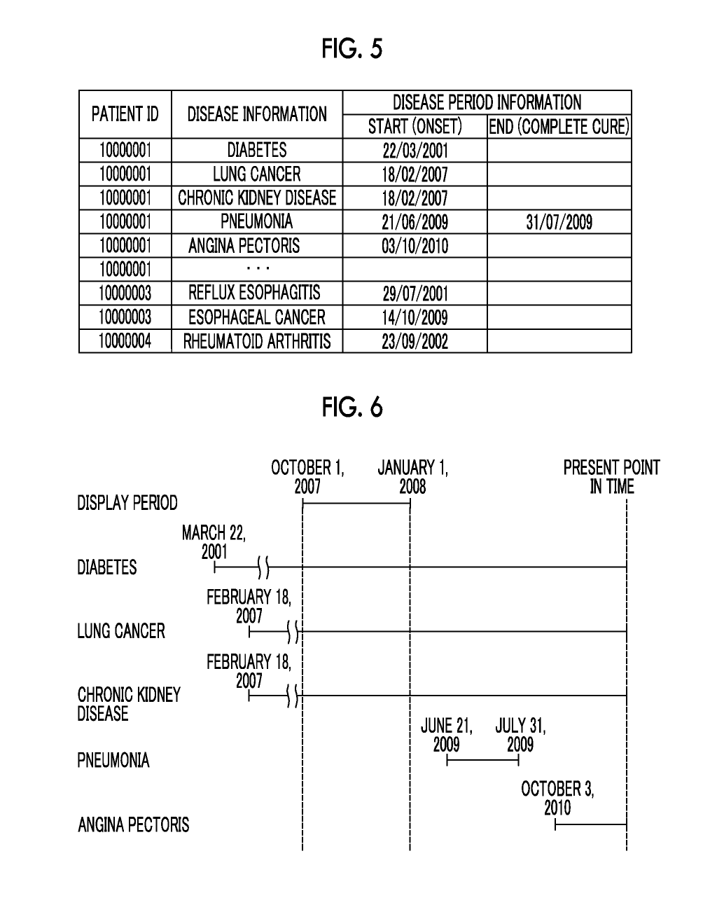

Disease information of a patient (patient ID: 10000001) and disease period information of the disease information are set as shown in a table of FIG. 5. In a case in which the display period of medical data designated by the user is a period of the past three months from Jan. 1, 2008, the relationship between the disease information of the patient (patient ID: 10000001) and the disease period information is a relationship shown in FIG. 6. Accordingly, first, as disease information to be displayed in a list, “diabetes”, “lung cancer”, and “chronic kidney disease” for which at least a part of the disease period is included in the above display period are specified. In addition, if priorities are set for such disease information in order of the start (onset) time close to the present time, “chronic kidney disease” and “lung cancer” have the same priority and a higher priority is set therefor, and a low priority is set for “diabetes”.

For the priorities of “chronic kidney disease” and “lung cancer”, for example, it is preferable to set the priorities in order of time, at which such disease information has been set and registered, close to the present time. Assuming that the disease information in the table shown in FIG. 5 has been set and registered in order from top to bottom, the highest priority is set for “chronic kidney disease”, and the next priority is set for “lung cancer”. As a result, “chronic kidney disease” has the highest priority, “lung cancer” has the next priority, and “diabetes” has the lowest priority.

The method of setting priorities based on the disease period information of the disease information is not limited to the above-described method. For example, priorities may be set in order of the start (onset) time far from the present time. In addition, a method of setting priorities in advance by the user may be used.

Without being limited to the method of setting priorities based on the disease period information described above, for example, the priority setting unit 17 may acquire the number of relevant medical treatment items for each of a plurality of pieces of disease information and set the higher priority as the number of items becomes larger.

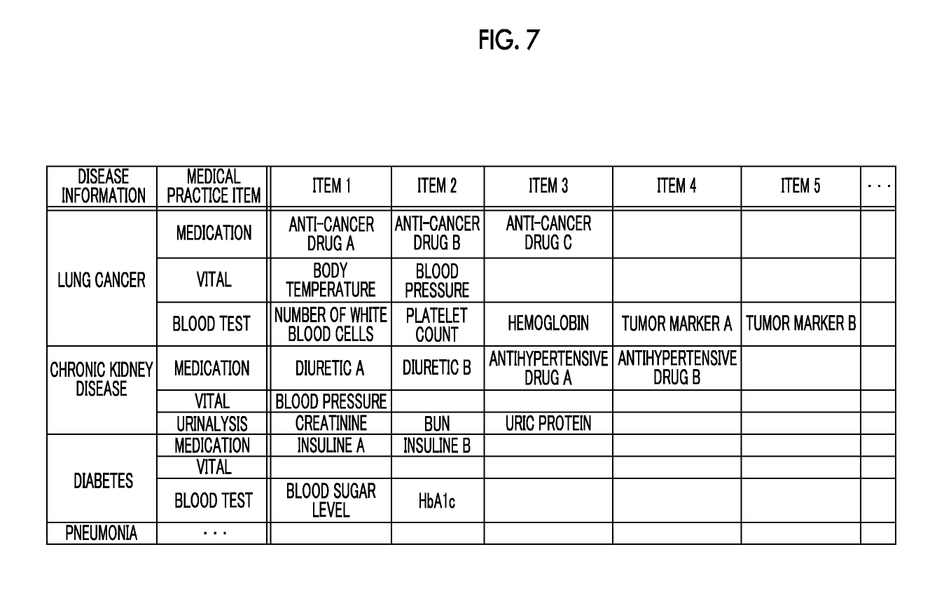

Specifically, for example, as shown in FIG. 7, in a case in which relevant medical treatment items are associated with each piece of disease information, three medical treatment items relevant to “medication”, two medical treatment items relevant to “vital”, and five medical treatment items relevant to “blood test” are present first for “lung cancer”. Accordingly, ten items as a total value of these values are acquired as an evaluation value when setting priorities. For “chronic kidney disease”, four medical treatment items relevant to “medication”, one medical treatment item relevant to “vital”, and three medical treatment items relevant to “urinalysis” are present. Accordingly, eight items as a total value of these values are acquired as an evaluation value. For “diabetes”, two medical treatment items relevant to “medication” and two medical treatment items relevant to “blood test” are present. Accordingly, four items as a total value of these values are acquired as an evaluation value.

In the case of setting priorities in descending order of evaluation values based on the evaluation values acquired as described above, the highest priority is set for “lung cancer”, the next priority is set for “chronic kidney disease”, and the lowest priority is set for “diabetes”. On the contrary, priorities may be set in ascending order of evaluation values.

In the above explanation, the number of items is set as an evaluation value as it is. However, for example, evaluation values may be acquired by giving a weighting according to the importance of each medical treatment item.

In addition, the priority setting unit 17 may acquire the information of the number of acquisitions of medical data of relevant medical treatment items for each of a plurality of pieces of disease information, and set the higher priority for disease information with the larger number of acquisitions.

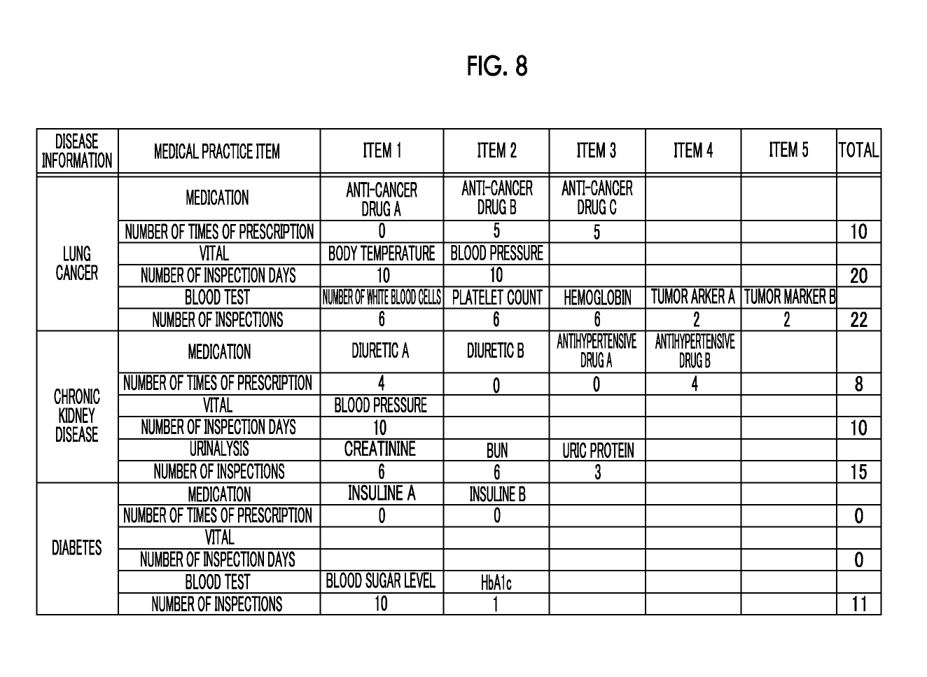

For example, as shown in FIG. 8, in a case in which medical treatment items relevant to “lung cancer” are “medication”, “vital”, and “blood test”, 10 times as the number of times of prescription of “medication”, 20 days as the number of inspection days of “vital”, and 22 times as the number of inspections of “blood test” are acquired. Accordingly, 52 times as a total value of these values are acquired as an evaluation value when setting priorities. The number of times of prescription, the number of inspection days, and the number of inspections that are shown in FIG. 7 are the number of times acquired during the display period designated by the user, that is, during the period of the past three months from Jan. 1, 2008.

Also for “chronic kidney disease”, similar to “lung cancer”, 33 times that is a total value of the number of times of prescription of “medication”, the number of inspection days of “vital”, and the number of inspections of “urinalysis” is acquired as an evaluation value. Also for “diabetes”, 11 times that is a total value of the number of times of prescription of “medication”, the number of inspection days of “vital”, and the number of inspections of “blood test” is acquired as an evaluation value.

In the case of setting priorities in descending order of evaluation values based on the evaluation values acquired as described above, the highest priority is set for “lung cancer”, the next priority is set for “chronic kidney disease”, and the lowest priority is set for “diabetes”. On the contrary, priorities may be set in ascending order of evaluation values.

In the above explanation, the number of acquisitions is set as an evaluation value as it is. However, for example, evaluation values may be acquired by giving a weighting according to the importance of each medical treatment item.

In addition, the priority setting unit 17 may acquire the information of the number of times of display of medical data of relevant medical treatment items or the information of the display period of medical data of relevant medical treatment items for each of a plurality of pieces of disease information, and set the higher priority for disease information with the larger number of times of display or the longer display period. The number of times of display of medical data is the number of times by which the user starts a diagnostic information display program to display medical data on the diagnostic information display screen, the display period of medical data is a time for which the medical data is displayed on the diagnostic information display screen, and these are assumed to be recorded in the priority setting unit 17, whenever medical data is displayed.

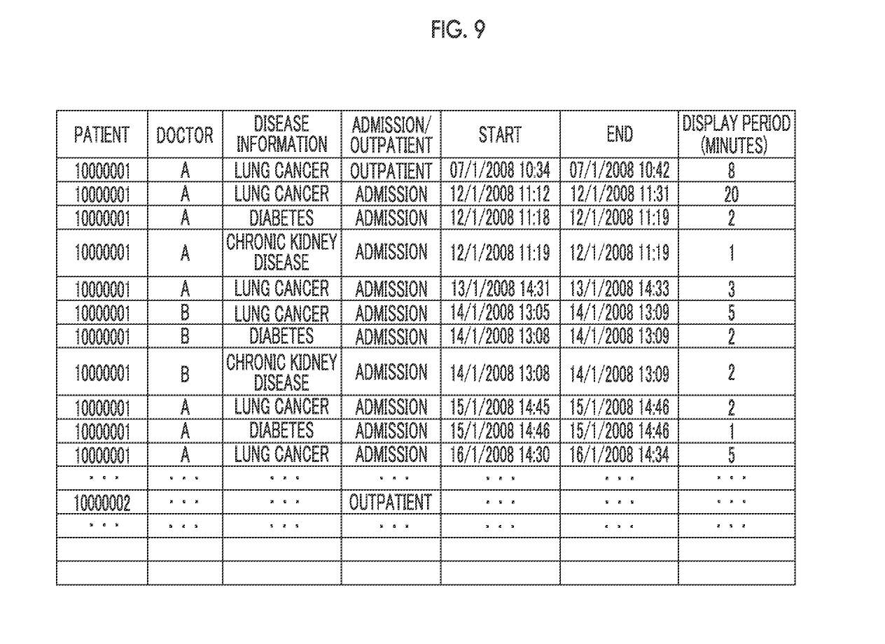

For example, as shown in FIG. 9, for the patient (patient ID: 10000001), a time for which the medical data of medical treatment items relevant to “lung cancer” is displayed, a time for which the medical data of medical treatment items relevant to “diabetes” is displayed, and a time for which the medical data of medical treatment items relevant to “chronic kidney disease” is displayed may be acquired and compared with each other, and priorities may be set based on the comparison result.

Specifically, in a case in which priorities are set in descending order of display period, the total value of the display period of “lung cancer” is 43 minutes, the total value of the display period of “diabetes” is 5 minutes, and the total value of the display period of “chronic kidney disease” is 3 minutes. Accordingly, the highest priority is set for “lung cancer”, the next priority is set for “diabetes”, and the lowest priority is set for “chronic kidney disease”.

In a case in which priorities are set in descending order of the number of times of display based on the number of times of display of medical data, the number of times of display of “lung cancer” is 6 times, the number of times of display of “diabetes” is 3 times, and the number of times of display of “chronic kidney disease” is twice. Accordingly, the highest priority is set for “lung cancer”, the next priority is set for “diabetes”, and the lowest priority is set for “chronic kidney disease”.

On the contrary, priorities may be set in ascending order of display period or in ascending order of the number of times of display.

In the above explanation, the display period or the number of times of display is set as an evaluation value as it is. However, for example, evaluation values may be acquired by giving a weighting according to the importance of each piece of disease information.

In addition, the priority setting unit 17 may acquire the information of the admission period of the patient, and set the priority of disease information in which the above admission period is included in the disease period, among a plurality of pieces of disease information, to be high.

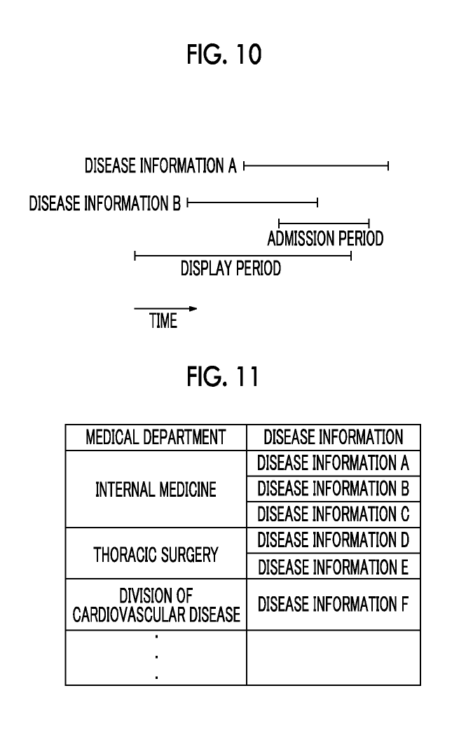

For example, in a case in which the admission period of the patient is included in any of the disease periods of “lung cancer”, “chronic kidney disease”, and “diabetes”, the priority of the disease information may be set to be high. The disease period and the admission period of each piece of disease information do not necessarily correspond to each other in a one-to-one manner. As shown in FIG. 10, in the admission period, not only disease information A but also disease information B may be present. In addition, there is also a case in which a patient has been diagnosed with the disease information A at first but the disease name is then changed to the disease information B. Accordingly, in a case in which an admission period is included in the disease period of a plurality of pieces of disease information, it is desirable to set the priority of disease information at the discharge point in time of the last of the admission period to be high. That is, in the case of the relationship shown in FIG. 10, it is desirable to set the priority of the disease information B to be higher than the priority of the disease information A. In addition, in a case in which there is disease information that does not include an admission period, the priority of the disease information is set to be lower than the priorities of the disease information A and the disease information B.

In addition, the priority setting unit 17 may acquire the information of a medical department to which the user, such as a doctor, belongs, and set the priority of disease information relevant to the information of the medical department, among a plurality of pieces of disease information, to be high.

Specifically, a table shown in FIG. 11, in which medical department information is associated with disease information relevant to the medical department information, may be stored in advance in the priority setting unit 17, and the priority setting unit 17 may set priorities with reference to the table based on the medical department information of the user set and input through the treatment department terminal 20. For example, in the case of setting priorities for “lung cancer” and “diabetes”, a higher priority may be set for “lung cancer” in a case in which the medical department information set and input by the user is “thoracic surgery”, and a higher priority may be set for “diabetes” in a case in which the medical department information set and input by the user is “internal medicine”.

In the embodiment described above, the user selects desired disease information from a plurality of pieces of disease information displayed in the disease information list display field R2, and the medical data of medical treatment items relevant to the selected disease information is displayed. However, instead of selecting desired disease information by the user as described above, disease information to be displayed of medical data may be automatically selected based on the priority set for each piece of disease information.

Specifically, for example, the display control unit 16 may automatically select disease information having the highest priority and disease information up to a priority set in advance from the highest priority, among a plurality of pieces of disease information for which priorities are set, and display the medical data of medical treatment items relevant to the selected disease information. The user may arbitrarily set up to which priority is to be selected.

In the embodiment described above, the disease period information is information indicating the period from the start (onset) to the end (complete cure) of each disease. However, an admission period relevant to each piece of disease information may be set as disease period information without being limited to the above. That is, the disease information acquisition unit 12 may acquire the information of the admission period relevant to each piece of disease information, and the display control unit 16 may display the list of disease information in which at least a part of the admission period is included in the display period.

In the embodiment described above, in a case in which the display period is changed, the changed list of disease information in which at least a part of the disease period is included in the display period after the change is displayed. In this case, however, in a case in which disease information to be displayed has been selected from the disease information list displayed before changing the display period, the selected disease information may be included in the disease information list after the change. That is, also in a case in which at least a part of the disease period of the selected disease information is not included in the display period after the change, the selected disease information may be included in the disease information list after the change. In this manner, it is possible to compare medical data relevant to the current disease information with medical data relevant to the past disease information, for example. In addition, in this manner, it is possible to prevent the content of the selected disease information from being unknown along with the change in the display period.

In a case in which disease information to be displayed of medical data is automatically selected and the display of the medical data is automatically updated, not only may the selected disease information be included in the changed disease information list, but also the selected medical data may be displayed so as to be included in the medical data. In this case, since medical data relevant to the disease after the change in the changed display period and the selected medical data in the changed display period are simultaneously displayed, it is easier to check the relationship between the selected disease and the past disease.

In a case in which disease information to be displayed of the medical data is automatically selected and the display of the medical data is automatically updated, in order to suppress the flickering of the screen, only the disease list may be automatically updated until the display period change operation is completed (during the display period change), and the medical data may be automatically updated at the point in time at which the display period change operation has been completed. The point in time at which the display period change operation is completed is, for example, a timing at which clicking is released after the selection of a display period is started by clicking a mouse.

What is claimed is:

1. A diagnostic information display control device, comprising:
a disease information acquisition unit that acquires disease information of a patient and information of a disease period of the disease information;
a corresponding medical treatment item information storage unit that stores corresponding medical treatment item information in which the disease information and medical treatment items relevant to the disease information are associated with each other;
a display period designation receiving unit that receives a designation of information of a display period for which medical data of the medical treatment items is displayed; and
a display control unit that displays a list of the disease information in which at least a part of the disease period is included in the display period and that acquires medical data of the medical treatment items, which are associated with at least one selected piece of disease information in the list of the disease information, based on the corresponding medical treatment item information and displays the acquired medical data in time series,
wherein, in a case in which the display period has been changed, the display control unit displays a changed list of disease information in which at least a part of the disease period is included in a display period after the change.

2. The diagnostic information display control device according to claim 1,
wherein, in a case in which the display period has been changed, for disease information selected in advance before the change, the display control unit continues to display the disease information in a disease list even if the disease period is not included in a display period after the change.

3. The diagnostic information display control device according to claim 1,
wherein, when an operation of changing the display period is received by the display period designation receiving unit and a time axis display of the display period is changed according to the change operation, the display control unit changes a list of the disease information to a list of disease information corresponding to the changed display period and displays the changed list, and for the medical data, displays in time series only medical data of the medical treatment items corresponding to disease information selected in advance before receiving the display period change operation and displays the medical data corresponding to a display period after the change according to the display period change operation.

4. The diagnostic information display control device according to claim 1, further comprising:
a priority setting unit that sets priorities for a plurality of pieces of disease information in a case of displaying the plurality of pieces of disease information in a list,
wherein the display control unit displays the plurality of pieces of disease information in a list based on the priorities.

5. The diagnostic information display control device according to claim 4,
wherein the display control unit automatically selects disease information having a highest priority and disease information up to a priority set in advance from the highest priority, among the plurality of pieces of disease information for which priorities are set by the priority setting unit, and displays medical data of medical treatment items relevant to the selected disease information.

6. The diagnostic information display control device according to claim 1, further comprising:
a disease information selection receiving unit that receives a selection of at least a piece of the disease information displayed in a list by the display control unit,
wherein the display control unit displays medical data of medical treatment items associated with the disease information received by the disease information selection receiving unit.

7. The diagnostic information display control device according to claim 4,
wherein the priority setting unit acquires information of the number of associated medical treatment items for each of the plurality of pieces of disease information, and sets a priority of the disease information based on the number of items.

8. The diagnostic information display control device according to claim 4,
wherein the priority setting unit acquires information of the number of acquisitions of medical data of the associated medical treatment items for each of the plurality of pieces of disease information, and sets a priority of the disease information based on the number of acquisitions.

9. The diagnostic information display control device according to claim 4,
wherein the priority setting unit acquires information of the number of times of display or information of display period of medical data of the associated medical treatment items for each of the plurality of pieces of disease information, and sets a priority of the disease information based on the number of times of display or the display period.

10. The diagnostic information display control device according to claim 4,
wherein the priority setting unit acquires information of an admission period of the patient, and sets a priority of disease information corresponding to the admission period, among the plurality of pieces of disease information, to be high.

11. The diagnostic information display control device according to claim 4,
wherein the priority setting unit acquires information of a medical department to which a user belongs, and sets a priority of disease information relevant to the medical department information, among the plurality of pieces of disease information, to be high.

12. The diagnostic information display control device according to claim 1,
wherein the disease period is set as a period from start to end of the disease information or as an admission period relevant to the disease information.

13. A diagnostic information display control method, comprising:
acquiring disease information of a patient and information of a disease period of the disease information;
receiving a designation of information of a display period for which medical data of medical treatment items is displayed;
displaying a list of the disease information in which at least a part of the disease period is included in the display period, and acquiring medical data of the medical treatment items, which are associated with at least a piece of disease information in the list of the disease information, and displaying the acquired medical data in time series; and
in a case in which the display period has been changed, displaying a changed list of disease information in which at least a part of the disease period is included in a display period after the change.

14. A non-transitory computer-readable recording medium having stored therein a diagnostic information display control program causing a computer to function as:
a disease information acquisition unit that acquires disease information of a patient and information of a disease period of the disease information;
a corresponding medical treatment item information storage unit that stores in advance corresponding medical treatment item information in which the disease information and medical treatment items relevant to the disease information are associated with each other;
a display period designation receiving unit that receives a designation of information of a display period for which medical data of the medical treatment items is displayed; and
a display control unit that displays a list of the disease information in which at least a part of the disease period is included in the display period and that acquires medical data of the medical treatment items, which are associated with at least a piece of disease information in the list of the disease information, based on the corresponding medical treatment item information and displays the acquired medical data in time series,
wherein, in a case in which the display period has been changed, the display control unit displays a changed list of disease information in which at least a part of the disease period is included in a display period after the change.
